(19) United States
(12) Patent Application Publication
(10) Pub. No.: US 2005/0207332 A1
(43) Pub. Date: Sep. 22, 2005

(54) Picture/sound output device with automatic output adjustment function

(75) Inventor: Hirotsugu Aoki, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/078,515

(22) Filed: Mar. 14, 2005

(30) Foreign Application Priority Data
Mar. 16, 2004 (JP) 2004-074146

(51) Int. Cl. H04J 15/00; H04L 5/20

(52) U.S. Cl. 370/200

(57) ABSTRACT

The invention provides a picture/sound output device with automatic output adjustment function which can reproduce an output level set in a predetermined time zone, and when a user changes the output level manually, can automatically adjust the output level of the subsequent time zones thereafter by using an output changing fraction. In the present invention, a signal processing section 1 reproduces signals, an output calculation section 6 calculates the output level of the subsequent time zone based on the three values consisting of a time zone output data level set in the present time zone stored in a storage section 2, a time zone output data level set in the subsequent time zone, and the present output level data, and then a control section 7 automatically adjusts the output level of the subsequent time zone to the output level calculated immediately before the time zone advances.

The present application is based on and claims priority of Japanese patent application No. 2004-074146 filed on Mar. 16, 2004, the entire contents of which are hereby incorporated by reference.

### BACKGROUND OF THE INVENTION

1. Field of the Invention

The present invention relates to a picture/sound output device which outputs a sound or a picture from an electric signal, such as a television set, a video player, a DVD player, a CD player, a radio set, or the like, wherein the picture/sound output device has an automatically adjustable output function that can automatically adjust an output level of sound volumes or pictures (such as brightness, contrast, sharpness, or the like) according to a time zone. According to the present specification, the “image/sound output device” includes devices such as a television set, a CD player, a radio set, or the like, which output a sound or a picture after reproducing an electrical signal, but excludes those devices that reproduce stored information of storing media such as a video player or a DVD player.

2. Description of the Related Art

Conventionally, there are known technologies in which an output level can be set according to a predetermined time zone and can be automatically adjusted according to a program set in the predetermined time zone. A reproduction device with an automatic output adjustment function is disclosed, for example, in the Japanese Patent Application Laid-Open Publication No. 2002-358716 (Patent Document 1).

According to the first aspect of the present invention, the reproduction device with an automatic output adjustment function comprises a reproduction signal processing section which performs signal reproduction, a user interface section which can input time zone information to indicate at least one time zone and setting information to set the output condition of reproduction output, a storage function section which stores the time zone information and the setting information of reproduction output, a judgment circuit which judges whether or not the real time of the signal reproduction is within the time zone specified by the time zone information, and a changing means which, if the requested reproduction start time is within the time zone, changes the reproduction signal processing section automatically to the output state based on the setting information.

According to this technology, when time zones and output levels for individual time zones are stored in the storage function section in advance, by using this data as a program, reproduction can be performed by changing the output level automatically to the output level corresponding to the time. A user can set the time zone and the level in the storage function section in advance, start the reproduction, adjust the output level in the midst of the reproduction, and end the reproduction. A specific example will be explained. First, the user inputs a time zone and an output level in advance. For example, suppose that in time zone 1 from 12:00 to 20:00 the sound volume is set to 25, in time zone 2 from 20:00 to 22:00 the sound volume is set to 30, and in time zone 3 from 22:00 to 24:00 the sound volume is set to 25. Then, the reproduction is started. For example, when the reproduction is started at 19:00 that corresponds to the time zone 1, the output level is automatically 25 from the beginning. When the reproduction is continued, the output level is automatically changed to 30 at 20:00 that corresponds to the time zone 2, and the output level is automatically changed to 25 at 22:00 that corresponds to the time zone 3. In other words, in accordance with the program inputted in advance, the output level is to be predetermined. When the user feels it necessary to change the output level that has been automatically determined, it is possible to change the output level freely. For example, by using the previous example, at the time of 21:00, the sound volume is 30 as set in advance, however, if the sound volume seems to be too high, it can be reduced to 20 accordingly.

In the conventional reproduction device described above, it is not possible to sufficiently achieve satisfactorily an object of the present invention for performing reproduction in an output condition and in a time zone desired by a user. An environment where the user watches and listens using a reproduction device is always changing. As for varying factors limiting to sounds only, there are time, surrounding sound, health condition, mood, and auditory condition of the audience, output level set in original signals themselves, the variety of output device (speaker or headphone), or the like. Therefore, it is not sufficient to fix the output level by using the time zone alone and not possible to comply with user's needs which vary moment by moment.

The situation will be explained by using the above-mentioned example. The reproduction is started at the time of 19:00 that corresponds to the time zone 1, and the output level of sound volume automatically started at 25. When the reproduction is continued, the output level is automatically changed to 30 at the time of 20:00 that corresponds to the start time of the time zone 2. At the time of 21:00, the sound volume is 30 as it has been set, but suppose that it seems to be too high and reduced to 20. Even in this case, at the time of 22:00, the output level is automatically raised to 25 because the time has advanced to the time zone 3. Ordinarily, at this time, the sound volume is normally set to a lower level by the user compared with the previous time zone. On the contrary, the output level actually is changed to a higher level. In this case, the user desired to adjust the output level somewhat lower than the normal setting and lowered the output level during the time zone 2. However, user's intention on that day is not reflected in the time zone 3 thereafter, and the output level is determined solely according to the setting registered in the storage function section.

In accordance with the situation of that time, the user desires the present reproduction, for example, with higher or lower sounds, or brighter or darker pictures than the setting and changes of each output level and the desired settings of the user must be done by himself/herself in the midst of the reproduction. However, according to the conventional example, it is necessary to change each output level from the beginning each time when the time zone advances thereafter.

### SUMMARY OF THE INVENTION

In order to solve the problem described above, an object of the present invention is to provide a picture/sound output device with automatic output adjustment function wherein the picture/sound output device can control output levels corresponding to time zones according to settings inputted in advance, and also when a user desires to change the output level higher or lower than the setting, can reflect the output level changed by user's operation to the output levels in the subsequent time zones thereafter.

The picture/sound output device with automatic output adjustment function according to the first aspect of the present invention comprises a signal processing section which can adjust an output level to output signals after signal reproduction, a storage section which stores time data of a predetermined time zone, reproduction output level data set for the time zone, and reproduction output level data of the present time, a user interface section which can set and change the reproduction output level of the predetermined time zone, a clock section which measures the present time, a time comparison section which judges the time zone corresponding to the present time by comparing the present time with the time data of the time zone, and an output calculation section which calculates the output level of the subsequent time zone in accordance with the time zone output level data set in the time data of the subsequent time zone by using a changing fraction between the time zone output level data set in the present time zone and the present output level data.

The picture/sound output device with automatic output adjustment function according to the second aspect of the present invention comprises the output calculation section which calculates the output level in the subsequent time zone according to the first aspect of the invention by using either one of the following calculation methods, that is,
[Output level value of the subsequent time zone]=([Present output level data value]/[Output level data value of the time zone set in the time data of the present time zone])×[Output level data value of the time zone set in the time data of the subsequent time zone],
and [Output level value of the subsequent time zone]=([Output level data value of the time zone set in the time data of the subsequent time zone]/[Output level data value of the time zone set in the time data of the present time zone])×[Present output level data value].

The picture/sound output device with automatic output adjustment function according to the third aspect of the present invention, in the invention according to the first or the second aspect of the invention comprises the output calculation section which calculates the output level by rounding off to whole numbers, because all the values of the output level data of the time zone set in the time data of the present time zone, the present output level data, and the output level data of the time zone set in the time data of the subsequent time zone are integers.

The picture/sound output device with automatic output adjustment function according to the fourth aspect of the present invention comprises the signal processing section which can output sound signals after reproduction and can adjust the output level of the sounds in the invention according to any one of the first to the third aspect of the invention.

The picture/sound output device with automatic output adjustment function according to the fifth aspect of the present invention comprises the signal processing section which can output picture signals after reproduction and can adjust the output level of pictures, in the invention according to any one of the first to the third aspect of the invention.

The picture/sound output device with automatic output adjustment function according to the sixth aspect of the present invention comprises the time data which can have at least 2 or more successive time zones in the time period of 24 hours, in the invention according to any one of the first to the fifth aspect of the invention.

According to the present invention, a user can not only set the output level in a time zone after setting the time zone, but can also automatically adjust the output level of the subsequent time zones thereafter by reflecting the changing fraction on the time zone output level data set when the present output level is changed by user's operation in the midst of the reproduction. The output level can be automatically adjusted to a higher level and to a lower level when the user changes it to the level higher and to the level lower than the time zone output data, respectively.

According to the present invention, even when the time zone advances by 2 or more time zones, the subsequent output level can always continuously be calculated by using the time zone output level data set in the present time zone, the actual present output level data, and the time zone output level data set in the subsequent time zone. Therefore, the changing fraction of the output level changed by user's operation continues to be reflected in the output level. Each time when the output level is changed by user's operation, the output level of the subsequent time zone calculated by the output calculation section is changed. By reflecting the changing fraction in the output level, the output level in the subsequent time zones thereafter can be automatically adjusted as desired by the user.

According to the present invention, by using the time zone output level data value set in the present time zone, the present output level data value, the time zone output level data value set in the subsequent time zone, and the output level value of the subsequent time zone can be calculated by the output calculation section, and the output level can be automatically adjusted when the time zone advances.

According to the present invention, the value itself changed by user's operation is not adjusted, but the changing fraction between the time zone output data value and the present output level data value is utilized. Therefore, it is possible to prevent making too large or too small adjustment compared with the output level data of the subsequent time zone.

According to the present invention, the output level of sounds (sound volume, tone, or the like) can be automatically adjusted. In addition, according to the present invention, the output level of pictures (brightness, color tone, contrast, sharpness, or the like) can be automatically adjusted.

According to the present invention, since at least 2 or more successive time zones can be set in a time period of 1 day or 24 hours, it is possible to automatically adjust the output level according to the time zone.

### BRIEF DESCRIPTION OF THE DRAWINGS

FIG. 1 is a drawing explaining an example of a arrangement of a picture/sound output device with automatic output adjustment function according to the present invention;

FIG. 2 is a drawing explaining an example of a flow chart for processing of the picture/sound output device with automatic output adjustment function according to the present invention; and

FIG. 3 is a drawing explaining one specific preferred example of automatic output adjustment function of the picture/sound output device with automatic output adjustment function according to the present invention.

### DETAILED DESCRIPTION OF THE PREFERRED EMBODIMENT

A preferred embodiment of the invention comprises a signal processing section which can adjust an output level by outputting signals after reproduction; a storage section which stores time data consisting of at least 2 or more successive time zones set, time zone output level data including a reproduction output level set for the time zone, the present output level data including the current output level data presently reproduced, the time data, the time zone output level data, and the present output level data; a user interface section which can set the output level for reproduction in a predetermined time zone by inputting at least the time data and the time zone output level data by having access to the storage section, and also can change the output level by having access to a control section; a clock section which measures the present time; a time comparison section which judges the time zone corresponding to the present time from the time data of the consistent time zone by comparing the present time with the time data; an output calculation section which calculates the output level of the subsequent time zone in accordance with the time zone output level data set in the time data of the subsequent time zone by using a changing fraction between the time zone output level data set in the time data of the present time zone and the present output level data; and a control section which can adjust the output level based on the time zone output level data set in the time data consistent with the present time, can adjust the output level based on a calculation result by the output calculation section when the present output level data of the previous time zone is changed to the time zone output level data as the time zone advances during reproduction, can adjust the output level in accordance with the operation of the user interface section, and can adjust the output level, in the case where each output level is different, first based on the operation of the user interface section, next based on the adjustment of the calculation result of the output calculation section, and then based on the time zone output level data of the present time in this order preferentially.

In the picture/sound output device with automatic output adjustment function according to the present invention, the signal processing section can output sound signals after reproduction and can adjust the output level of sounds, or simultaneously can output picture signals after reproduction and can adjust the output level of pictures. With regard to the adjustment of the output level of pictures, it is possible to adjust the output level of brightness, to adjust the output level of color tone, to adjust the output level of contrast, and to adjust the output level of sharpness.

In the picture/sound output device with automatic output adjustment function according to the present invention, the time data can be set for at least 2 or more successive time zones for a period of 24 hours. According to this arrangement, it is possible to set and store a plurality of time zone output level data of various kinds in the storage section for one time zone and it is possible to automatically adjust various, different kinds of output levels in accordance with the time zone.

In the picture/sound output device with automatic output adjustment function according to the present invention, it is possible to turn on/off the function of the output calculation section which calculates the output level of the subsequent time zone by using the present changing fraction. In addition, it is also possible to turn on/off the function to automatically adjust the output level based on the time zone output data set in the time data of the present time zone.

In the picture/sound output device with automatic output adjustment function according to the present invention, when the power switch of the picture/sound output device is turned off, the time data and time zone output data stored in the storage section are stored and can be used in the next reproduction operation. On the other hand, the present output data is cleared, and when the power switch is turned on next time, it will be newly stored.

In the picture/sound output device with automatic output adjustment function according to the present invention, the preferred embodiment of the present invention described above is adopted, and in addition, to those items described regarding the effects of the invention, it is possible to automatically adjust a plurality of various kinds of output levels (for example, sound volume, picture brightness, or the like) depending on the time zone by setting and storing a plurality of various kinds of time zone output level data for each time zone set in the storage section. In addition, by turning on the function of the output calculation section for calculating the output level of the subsequent time zone based on the present changing fraction, it is possible to automatically adjust the output level by reflecting the changing fraction changed by user's operation on the output level of the time zone thereafter. Also, by turning off the above function, it is possible to automatically adjust the output level in accordance with the time zone output level data without reflecting the changing fraction changed by user's operation on the output level of the time zone thereafter, thereby enabling the switching of turning on/off of the above function to be made selectively by the user. Furthermore, by turning on the function to automatically adjust the output level based on the time zone output data set in the time data of the present time zone, it is possible to automatically adjust the output level in accordance with the time zone output level data, and also in that state, it is possible to reflect the changing fraction changed by user's operation on the output level of the time zone thereafter, thereby enabling the switching of turning on/off of this function to be made selectively made by the user. In addition, the present output level data, which might be changed by user's operation or might be adjusted automatically, does not influence the output level at all when the reproduction operation is started next time by turning on the power switch. Even if, at the previous reproduction time, the output level is higher or lower than the time zone output level data set up, reproduction is performed at the output level of the time zone output level data set in the time zone as it is when the reproduction operation is newly started. According to this arrangement, at the next start time of reproduction, it is possible to prevent a sudden start of reproduction at the output level higher or lower than the time zone output level data set up in advance.

Hereinafter, further, an example of the preferred embodiment of the picture/sound output device with automatic output adjustment function according to the present invention will be explained by referring to the drawings. Please note that present invention is not limited only to the present embodiment. In the present embodiment, as a specific example, the sound volume (volume), which is one item of the output levels for sound reproduction, is explained, however, the present invention relates to the automatic adjustment of various kinds of output levels with regard to sounds in addition to the sound volume and also various kinds of output levels with regard to pictures, in a manner similar to that of the sound volume.

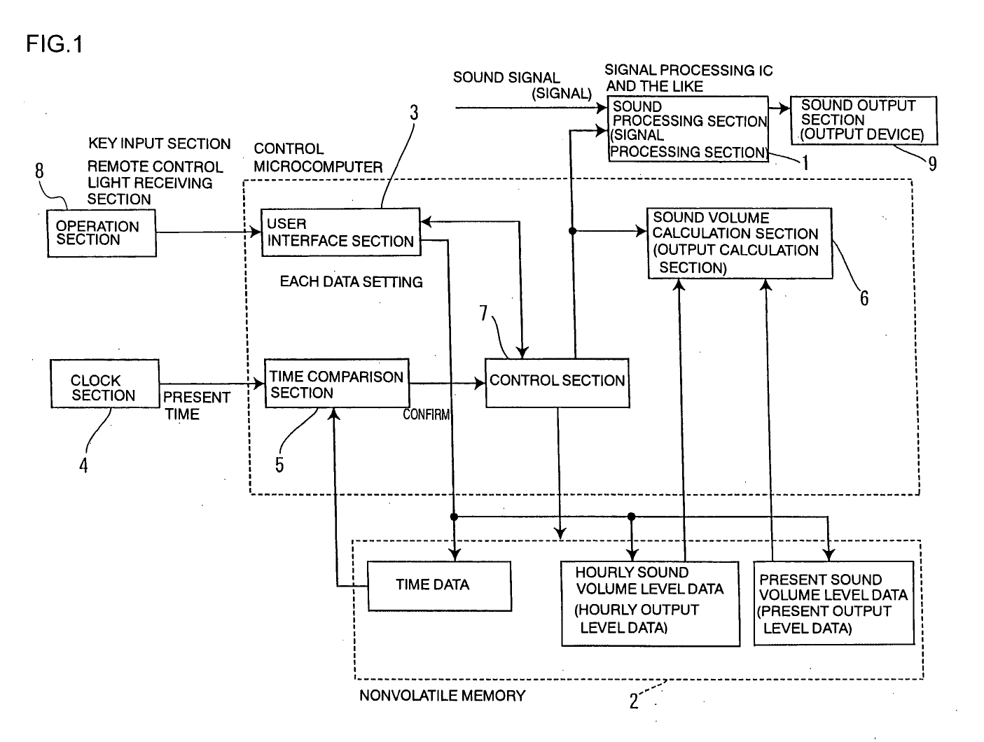

FIG. 1 shows one example of a block diagram constituting a picture/sound output device which outputs sound signals having an automatically adjustable output level of sound volume. The portion which reproduces sounds from sound signals (signals) comprises a sound processing section (signal processing section) 1 and a sound output section (output device) 9. In the signal processing section 1, signal processing IC and the like are used in practice. The output device 9 employs a speaker, a headphone, an earphone, or the like, and outputs sounds reproduced by the signal processing section 1. The sound level (output level) of the signal processing section 1 is controlled by a control microcomputer. The control microcomputer section comprises a user interface section 3, a time comparison section 5, a control section 7, and an output calculation section 6. The user interface section 3 receives information key-inputted from an operation section 8 of a front panel or remote control, transmits it to the control section 7, and stores setting information in a nonvolatile memory (storage section) 2. Information stored in the storage section 2 includes time data to specify a time zone inputted via the user interface section 3 and sound volume level data of the individual time zone (time zone output level data), and in addition, it includes a current sound volume data (current output level data) in which the sound volume level (output level) of the current reproduction is automatically stored.

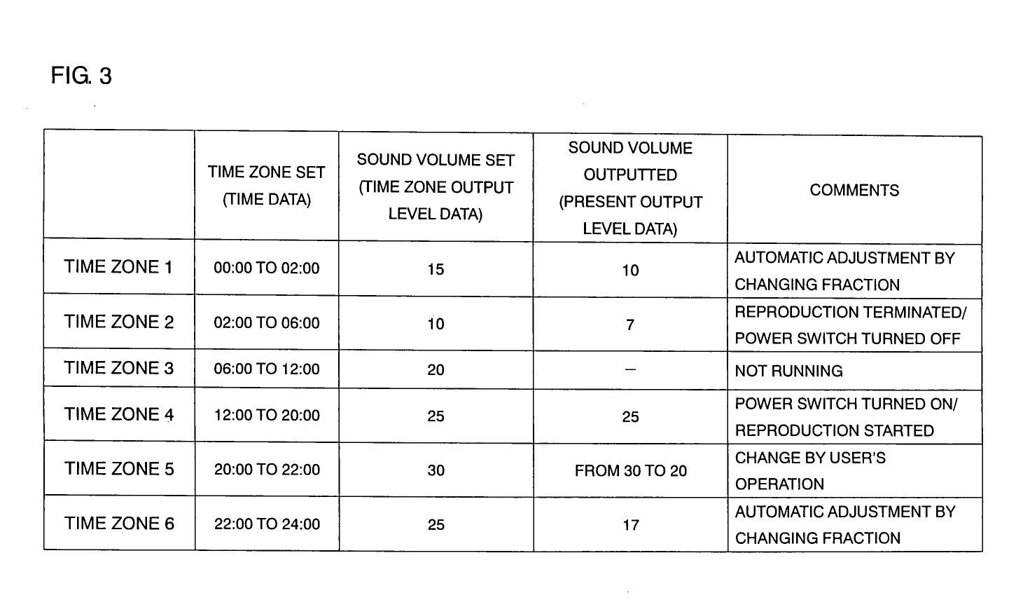

The time data includes data for at least 2 or more successive time zones in a period of 24 hours. As will be described later, for example, when the time zone is set as shown in FIG. 3, time zone 1 to time zone 6 are set. The time zone output level data includes the sound volume level data of each time zone stored in the time data. The time data and time zone output level data stored in the storage section 2 are to be inputted in advance before the start of reproduction. The current sound volume data (current output level data) is stored together with sound volume and the like.

At the start time of reproduction, the time comparison section 5 receives the time information of the present time outputted from the clock section 4 and compares it with the time data of the time zone set in advance (the start time data and end time data of each time zone) and sends the time zone information regarding the time zone corresponding to the present time to the control section 7. Then, the time zone output level data (sound volume level data) itself set in the time zone of the present time is given to the signal processing section (sound processing section) 1, and a calculation result by the output calculation section (sound volume calculation section) 6 is given for the time zone thereafter. A user instructs the control section 7 by key-inputting operation via the user interface section 3 by using a remote control unit and the like and can change the present output level (sound volume) directly.

The time comparison section 5 compares the time information periodically transmitted from the clock section 4 with the time data of the time zone set in advance and sends the time zone information regarding the time zone corresponding to the present time to the control section 7. When the control section 7 judges that the present reproduction time is immediately before the time advances from the present reproduction time zone to the subsequent time zone, the control section 7, in accordance with the information inputted from the time comparison section 5, obtains the time zone output level data stored in the storage section 2 and the present output data, and sends instructions and the like to the output calculation section 6 (sound volume calculation section). The output calculation section 6 (sound volume calculation section) calculates the output level (sound volume level) of the subsequent time zone in accordance with the time zone output level data (sound volume level data) set in the time data of the subsequent time zone by using the changing fraction between the time zone output level data (sound volume level data) set in the time data of the present time zone stored in the storage section 2 and the present output level data (present sound volume data). The output level (sound volume level) of the calculation result is given to the signal processing section 1 (sound processing section).

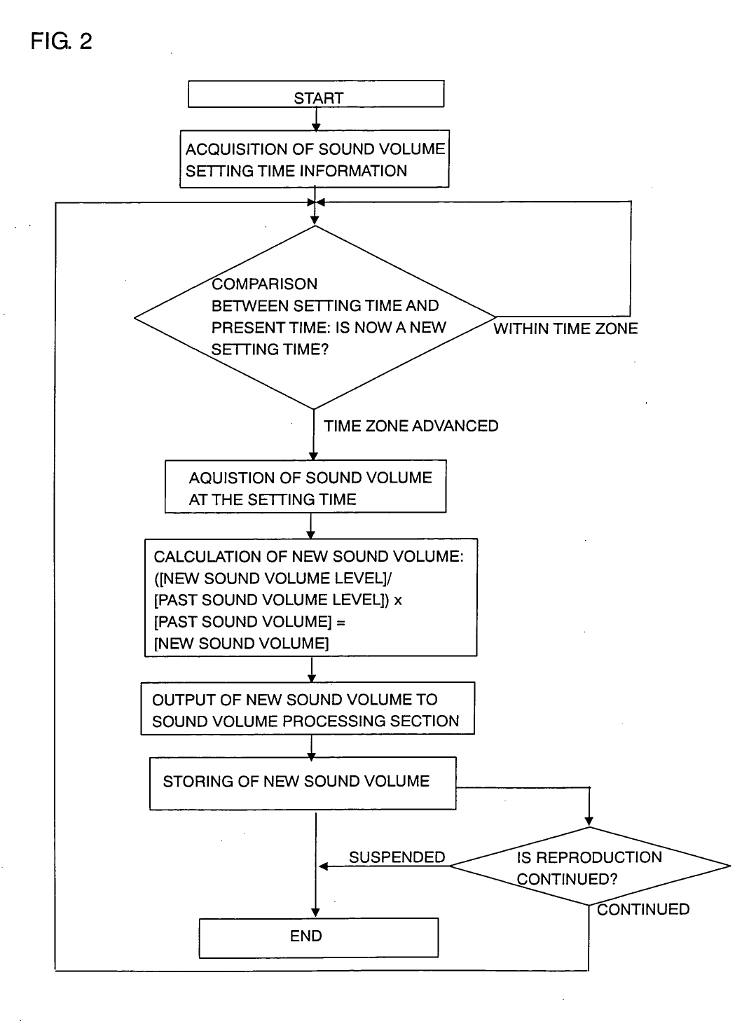

FIG. 2 shows one example of a flow chart of the flow process of the operational outline of the picture/sound output device to output sound signals having an automatically adjustable sound volume output level. First, reproduction of the picture/sound output device is started in “Start” step. Next, the time data of the time zone corresponding to the present time is obtained from the storage section 2 in “Acquisition of sound volume setting time information” step. Then, the present time of the clock section 4 and the time data are compared in “Comparison between setting time and present time: Is now a new setting time?” step. When there is no advance in time zone, again the “Comparison between setting time and present time: Is now a new setting time?” step is repeated, and when the time zone advances to a new setting time, the new time zone output level data set in the advanced time zone is obtained in “Acquisition of sound volume at the setting time” step and the output calculation section 6 calculates a new output level (sound volume) based on the data of the storage section 2 using the calculation formula in “Calculation of new sound volume ([New sound volume level]/[Past sound volume level])×[Past sound volume]=[New sound volume]” step. Further, in the “Comparison between setting time and present time: Is now a new setting time?” step, when there is no advance in time zone, it is possible to end the reproduction operation in “End” step within the time limit of the time zone at the start time of reproduction before a new setting time starts.

According to the flowchart shown in FIG. 2, a calculation is to be performed after the time zone changes, but the calculation may be performed before the time zone changes. In either case, the time when the past sound volume (present output level data) is finally determined is the time point when both the previous time zone ends and the time point when the subsequent time zone starts at the same time. In any case, the two time points are identical and the same content is expressed simply by using different words. A calculation method of “([New sound volume level]/[Past sound volume])×[Past sound volume]=[New sound volume]” is absolutely identical to a calculation method of “([Output level data value of the time zone set in the time data of the subsequent time zone]/[Output level data value of the time zone set in the time data of the present time zone])×[Present output level data value]=[Output level value of the subsequent time zone]”. Next, in “Output of new sound volume to sound volume processing section” step, the output level (sound volume level) of the calculation result is given to the signal processing section 1.

Next, in “Storing of new sound volume” step, sounds are outputted from the output section 9 (sound volume output section), and the new sound volume level outputted is stored in the storage section 2 as the present output level data (past sound volume). Afterward, when the user changes the output level (sound volume) by operating remote control and the like, this changed data is stored in the storage section 2. Then, when the reproduction operation is terminated within the time limit of the time zone, this flow process is ended in “End” step, and when the reproduction operation is continued, the process is returned to the “Comparison between setting time and present time: Is now a new setting time?” step and is repeated from the “It Is now a new setting time?” step.

FIG. 3 shows a specific example of setting and automatic output adjustment function of the picture/sound output device to output sound signals having an automatically adjustable sound volume output level. FIG. 3 shows the state in which the user, by using remote control and the like, sets 6 successive time zones with desired time intervals for a period of 24 hours taking 00:00 as the base point, that is, [00:00 to 02:00], [02:00 to 06:00], [06:00 to 12:00], [12:00 to 20:00], [20:00 to 22:00], and [22:00 to 24:00], and sets time zone output level data (sound volume level data) of [15], [10], [22], [25], [30], and [25] for each time zone, respectively.

In this time zone setting, as shown in FIG. 3, the user may set the desired times, or a method can be adopted in which the period of 24 hours is automatically divided into predetermined time zones by grouping time zones having a similar sound level into a single time zone after the device itself statistically analyzes user's usage pattern (settings and changes of the sound volume level). In addition, it is also possible to adopt a method in which the time period of 24 hours is divided by a predetermined interval from the beginning, for example, into 12 time zones each having a 2-hour interval, and then, the user inputs settings of the sound volume level for each of the time zones.

Next, FIG. 3 explains the case where the power switch of the picture/sound output device is turned on at 19:00 and reproduction is started. The time zone corresponding to the current time is [12:00 to 20:00], and since the time zone output level data set in this time zone is [25], sounds are reproduced at the output level (sound volume level) of 25 and the sound volume 25 is stored as the present output level data as it is. As the time zone advances to [20:00 to 22:00] without any change, the output calculation section 6 performs a calculation of “(30/25)×25=30” and the sound volume is raised to 30 which is the same as the time zone output level data which has been set for this time zone. However, at 21:00, the sound volume is lowered to 20 by user's operation change, and the value of the present output level data is also changed to 20. Then, as the time zone advances to [22:00 to 24:00], the output calculation section 6 performs a calculation of “(25/30)×20=16.66 (17 by rounding off to a whole number)” and the sound volume is lowered to 17. And, the present output level data is also stored as 17. Then, as the time zone advances to [00:00 to 02:00], the output calculation section 6 performs a calculation of “(15/25)×17=10.2 (10 by rounding off to a whole number)” and the sound volume is lowered to 10. And, the present output level data is also stored as 10. Then, as the time zone advances to [02:00 to 06:00], the output calculation section 6 performs a calculation of “(10/15)×10=6.66 (7 by rounding off to a whole number)” and the sound volume is lowered to 7. And, the present output level data is also stored as 7. Then, at the time of 03:00, the user turns off the power switch to terminate reproduction and the present output level data stored in the storage section 2 is deleted.

According to the present embodiment, next, for example, when the reproduction operation is started again at 19:00, an example is explained in the case where the reproduction starts at the sound volume of 25, which is the same value as the value [25] of the time zone output level data set in the time zone. However, the sound volume level data set up may be corrected and changed to the output levels such as [20], [17], [10], and [7].

When the output level (sound volume) is changed by user's operation via the user interface section 3, the changing fraction can be obtained based on the setting output level data of the present time, and the subsequent output level can be calculated by reflecting this changing fraction on the setting output level data of the subsequent time zone. The calculation method performed by the output calculation section 6 (sound volume calculation section) is based on the two formulas of ([Present output level data value]/[Output level data value of the time zone set in the time data of the present time zone])×[Output level data value of the time zone set in the time data of the subsequent time zone]=[Output level value of the subsequent time zone] and ([Output level data value of the time zone set in the time data of the subsequent time zone]/[Output level data value of the time zone set in the time data of the present time zone])×[Present output level data value]=[Output level value of the subsequent time zone]. However, since the calculation results are the same, either one of them may be used. In the above-mentioned embodiment, the latter formula is used. When the output level is changed by user's operation, in order to reflect the output change on the time zones thereafter, two methods can be considered, one is to add or subtract uniformly an amount of change and the other is to reflect the fraction of change. However, for example, when the user changes the setting output level (sound volume) of 10 to 5, and in case the setting of the subsequent time zone is 5, the output level of the sound volume becomes zero in the uniform addition/subtraction method because of “5−5=0”, however, in the method to reflect the changing fraction as in the case of the present invention, the output level can be automatically adjusted to 3 because of “(5/10)×5=2.5 (3 by rounding off to a whole integer)”.

1. A picture/sound output device with automatic output adjustment function comprising a signal processing section which can adjust an output level to output signals after signal reproduction, a storage section which stores time data of a predetermined time zone, reproduction output level data set for the time zone, and reproduction output level data of the present time, a user interface section which can set and change the reproduction output level of the predetermined time zone, a clock section which measures the present time, a time comparison section which judges the time zone corresponding to the present time by comparing the present time with the time data of the time zone, and
an output calculation section which calculates the output level of the subsequent time zone in accordance with the time zone output level data stored in the time data of the subsequent time zone by using a changing fraction between the time zone output level data set in the present time zone and the present output level data.

2. The picture/sound output device with automatic output adjustment function according to claim 1, wherein the output calculation section calculates the output level in the subsequent time zone by using either one of the following calculation methods, that is,
[Output level value of the subsequent time zone]=([Present output level data value]/[Output level data value of the time zone set in the time data of the present time zone])×[Output level data value of the time zone set in the time data of the subsequent time zone] and
[Output level value of the subsequent time zone]=([Output level data value of the time zone set in the time data of the subsequent time zone]/[Output level data value of the time zone set in the time data of the present time zone])×[Present output level data value].

3. The picture/sound output device with automatic output adjustment function according to claim 1 or claim 2, wherein the output calculation section calculates the output level by rounding off to the whole numbers because all the values of the output level data of the time zone set in the time data of the present time zone, the present output level data, and the output level data of the time zone set in the time data of the subsequent time zone are integers.

4. The picture/sound output device with automatic output adjustment function according to claim 1 or claim 2, wherein the signal processing section can output sound signals after reproduction and can adjust the output level of sounds.

5. The picture/sound output device with automatic output adjustment function according to claim 1 or claim 2, wherein the signal processing section can output picture signals after reproduction and can adjust the output level of pictures.

6. The picture/sound output device with automatic output adjustment function according to claim 1 or claim 2, wherein the time data can have at least 2 or more successive time zones in a time zone of 24 hours.
